(19) United States
(12) Patent Application Publication
(10) Pub. No.: US 2014/0270623 A1
(43) Pub. Date: Sep. 18, 2014

(54) CAPILLARY ACTION FIBER SENSOR

(71) Applicants: Syed Yosuf Ahmed, Senneville (CA); Olivier Bataille, Kirkland (CA); Colin Michael Hassey, Barrie (CA)

(72) Inventors: Syed Yosuf Ahmed, Senneville (CA); Olivier Bataille, Kirkland (CA); Colin Michael Hassey, Barrie (CA)

(73) Assignee: Plexis Precision Inc., Montreal (CA)

(21) Appl. No.: 13/834,746

(22) Filed: Mar. 15, 2013

(51) Int. Cl. G01L 11/02

(52) U.S. Cl. CPC G01L 11/025
USPC 385/12

(57) ABSTRACT

The present invention relates to optical fiber pressure sensors. In one embodiment, liquid pressure of an environment may be measured based on capillary action occurring within an optical fiber having one or more hollow columns within. In another embodiment, the change in environmental pressure may be measured based on light diffracted from an optical fiber having optical grating. In either embodiment, the pressure sensor is manufactured from a single optical fiber.

### CROSS-REFERENCE TO RELATED APPLICATION

n/a

### STATEMENT REGARDING FEDERALLY SPONSORED RESEARCH OR DEVELOPMENT

n/a

### FIELD OF THE INVENTION

The present invention relates to optical fiber pressure sensors that are based on either the theory of capillary action or the theory of optical grating. In either embodiment, the pressure sensor is manufactured from a single optical fiber, eliminating the need for bonding together multiple components, which can adversely affect the accuracy of pressure measurements.

### BACKGROUND OF THE INVENTION

Miniaturized pressure sensors are commonly used in modern devices, and are suitable for use in a variety of industries, especially the medical field. Ongoing research in miniaturized pressure sensors has produced many types of pressure sensors, including those manufactured using optical fibers.

Optical fibers are preferred over other types of pressure sensors for medical procedures because optical fibers may be biocompatible, chemically inert, and immune to electromagnetic interference. Further, plastic optical fibers, because of their flexibility, are preferable to glass or silica optical fibers for uses that do not require a high transmission capacity.

Although optical-fiber-based pressure sensors are becoming increasingly popular, there are still some associated drawbacks. The most notable problem with currently known optical-fiber-based pressure sensors is that the sensor includes multiple components that all must be bound to each other and/or the optical fiber. For example, most optical fiber pressure sensors known in the art include a flexible membrane that flexes as the environmental pressure changes. The pressure measurement in these sensors is a function of the material of the membrane, and so the membrane must be hermetically sealed within the sensor to preserve the integrity of the membrane and prevent interference by outside substances. Sealing the membrane within the pressure sensor requires bonding several components of the sensor together.

In most cases, these bonds are not chemically inert and do not match the chemical and physical stability of other parts of the pressure sensor with respect to the environment. Additionally, the multiple parts of the pressure sensor generally do not all have the same thermal coefficient of expansion. These inconsistencies lead to measurement inaccuracies and the need for frequent recalibration, particularly whenever there is a change in environmental temperature.

Therefore, it would be desirable to produce a miniaturized optical fiber pressure sensor that is entirely fabricated from a single component. The optical fiber pressure sensors described herein are fabricated only from a single optical fiber, and do not require any other components to be coupled thereto. Using the principles of capillary action and optical grating, it is possible to accurately measure pressure of a liquid and gaseous environment with a single-component optical fiber pressure sensor. Such an optical fiber pressure sensor may be useful for medical procedures such as taking real-time blood pressure measurements.

### SUMMARY OF THE INVENTION

The optical fiber pressure sensors described herein are fabricated only from a single optical fiber, and do not require any other components to be coupled thereto. These optical fiber pressure sensors are not only simpler to manufacture and use, but also are more accurate, do not require recalibration, and have a longer life than other optical fiber pressure sensors.

In one embodiment, the optical fiber pressure sensor may measure the pressure of a liquid using capillary action. Within the optical fiber may be one or more hollow (evacuated) columns that contain a gas, solid, liquid, or gel. The one or more columns may be composed of or coated with a hydrophobic material and sized so that liquid in the environment flows against gravity and into the one or more columns. The height to which the liquid rises within the one or more columns is a function of the pressure of the liquid in the environment, and the height may be used to determine the pressure of the liquid in the environment using such techniques as interferometry, spectrometry, or optical coherence tomography.

In another embodiment, the optical fiber pressure sensor may measure the pressure of a liquid or a gas using optical grating. Here, the material properties of the optical fiber are used to measure pressure. Optical grating comprising a plurality of grooves may be etched onto the distal end of the optical fiber, and the optical grating may diffract incident light that. The pressure of the environment may compress the optical fiber, the degree of compression depending on the material of the optical fiber, thereby reducing the distance between the grooves of the optical grating. As the distance between the grooves changes with pressure, the direction of diffraction of the incident light may also change.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1A shows a first view of a capillary-action-type optical fiber pressure sensor;

FIG. 1B shows a second view of the capillary-action-type optical fiber pressure sensor of FIG. 1A;

FIG. 2 shows a measurement system incorporating the optical fiber pressure sensor of FIG. 1;

FIG. 3A shows a first view of an alternative method of measuring pressure using the capillary-action-type optical fiber pressure sensor;

FIG. 3B shows a second view of the alternative method of measuring pressure using the capillary-action-type optical fiber pressure sensor of FIG. 3A;

FIG. 4A shows a first view of an optical-grating-type optical fiber pressure sensor;

FIG. 4B shows a second view of the optical-grating-type optical fiber pressure sensor of FIG. 4A; and

FIG. 5 shows a measurement system incorporating the optical fiber pressure sensor or FIG. 3.

### DETAILED DESCRIPTION OF THE INVENTION

Referring now to FIGS. 1A and 1B, a capillary-action-type optical fiber pressure sensor is shown. The optical fiber 12 may consist of a core 13 and a cladding 14. Although the most commonly used core material is poly(methyl methacrylate) (PMMA), the core may also be composed of other suitable materials such as an azypolymer or an amorphous perfluorinated polymer. The cladding 14 may consist of a fluorinated polymer or other suitable materials such as polyethylene (PE), polyvinyl chloride (PVC), propylene, crosslinked polyethylene, polyamide, silica, or fluoride- or phosphate-based glass fibers.

The optical fiber 12 may include a distal end 15 and a proximal end 16, and may either be a solid-core optical fiber or a hollow optical fiber. If a solid core optical fiber is used, one or more longitudinal evacuated (hollow) columns 18 may be machined or etched into the distal end 15 of the optical fiber 12. The one or more columns 18 are referred to as “evacuated” or “hollow,” regardless of whether they may contain a liquid or other substance. The one or more evacuated columns 18 may either extend longitudinally along the core 13 for the entire length of the optical fiber 12 (from the distal end 15 to the proximal end 16; as shown in FIGS. 1A and 1B), or may be a “blind” column that extends longitudinally along the core 13 of the optical fiber 12 for a distance from the distal end 15 but not reaching the proximal end 16 (as shown in FIG. 2). The distance over which the one or more blind columns 18 extend may be dependent on the needs of the user, the environment in which the optical fiber pressure sensor 10 will be used, the material of the optical fiber, etc. Additionally, the one or more evacuated columns 18 may either have a single diameter or varying diameters along their length. If varying diameters are used, the one or more evacuated columns 18 may comprise discrete diameter values or diameter values that gradually increase or decrease along their length, so that the one or more evacuated columns 18 may have unique geometries. Furthermore, the diameter of the one or more evacuated columns may have shapes other than a circle. For example, a blind column 18 may have an elliptical shape with a polygonal cross section.

The one or more evacuated columns 18 may contain the gas 20 of the gaseous environment, which may freely ingress and egress when the optical fiber 12 is not submerged in a liquid. Alternatively, the one or more evacuated columns 18 may contain one or more solids, liquids, or gels. Under the theory of capillary action, the forces of adhesion and cohesion with a liquid enable the liquid to flow against gravity and upward into a capillary tube, such as the one or more evacuated columns 18 of the optical fiber pressure sensor 10. Not only may capillary action be used to measure liquid pressure, but it may also be used to keep the one or more solids, liquids, or gels contained within the one or more evacuated columns 18.

The distal end 15 of the optical fiber pressure sensor 10 may be placed into a liquid 22 whose pressure is to be measured using capillary action. The height the liquid reaches within the one or more evacuated columns 18 (as shown in FIG. 1B), or penetration, is a function of the pressure exerted by and the surface tension of the liquid 22. The diameter of the one or more evacuated columns 18 may be sized to allow for capillary action; that is, the diameter of the one or more evacuated columns 18 may be of a size that enables cohesive and adhesive forces of the liquid allow the liquid to rise and trap the gas 20 within the one or more evacuated columns 18. For example, the diameter of the one or more evacuated columns 18 may be between 5 nm and 10 mm.

In addition to the diameter of the one or more evacuated columns 18, however, the material of the fiber 12 and its interaction with the liquid 22 may be considered. The material of the fiber 12 must interact with the liquid 22 so that the wetting angle (the angle at which the liquid meets the solid surface) of the liquid 22 is greater than 90 degrees to optimize liquid 22 penetration and ensure that the liquid 22 remains in the one or more evacuated columns 18. If the material of the optical fiber 12 and the liquid 22 do not interact to produce a wetting angle of at least 90 degrees, a coating material 24 may be applied to the surface of the one or more evacuated columns 18. The coating material may be applied in a thin film, such as a film with a thickness of approximately 75 nm or less.

Referring now to FIG. 2, the liquid pressure may be measured using a device 28 such as an interferometer (such as a Fabry-Perot interferometer), spectrometer, or optical coherence tomograph, which are well known in the art. As shown in FIG. 2, the evacuated column 18 may be a blind column that does not extend the full length of the optical fiber 12. The pressure at which the liquid 22 enters the one or more evacuated columns 18, may serve as the reference point for the device 28. This device may be an interferometer or spectrometer, which are well known in the art. The device 28 may be coupled to the proximal end 16 of the optical fiber 12. The device 28 may send waves of light (generally depicted with arrows) longitudinally through the core 13 of the optical fiber 12 to the distal end 15 of the optical fiber 12, and may detect the waves of light (generally depicted with arrows) that are transmitted back to the device 28. (General directions of light are depicted with arrows in FIG. 2.) The volume of liquid 22 within the one or more evacuated columns 18 will affect the waves of light that are transmitted to and detected by the device 28. The device 28 will then correlate the amount of transmitted light to the penetration of the liquid 22 within the one or more evacuated columns 18, and then communicate the comparison as a pressure reading.

Now referring to FIGS. 3A and 3B, a different measurement method may be conducted using capillary action. As an alternative to the pressure measuring system discussed above, environmental pressure may be measured using interferometry, spectrometry, or optical coherence tomography (OCT) using the interface between a gaseous or liquid environment and one or more solids, liquids, or gels 29 contained within the one or more evacuated columns 18 of the optical fiber pressure sensor 10. The one or more solids, liquids, or gels 29 may be prevented from falling out of the one or more evacuated columns 18 by the forces of adhesion and cohesion that occur in capillary action, and essentially create a membrane 30. The location of this membrane 30 may be affected by the environmental pressure, the location being detected and correlated to a pressure measurement by interferometery, spectrometery, or OCT. For example, as pressure increases, the membrane 30 may be located higher within the one or more evacuated columns 18 (as shown in FIG. 3B) than under lower pressure conditions (as shown in FIG. 3A).

Referring now to FIGS. 4A and 4B, an optical-grating-type optical fiber pressure sensor is shown. As shown in FIGS. 4A and 4B, the optical fiber pressure sensor may be a solid piece of material. The optical fiber 12 includes a distal end 15 and a proximal end 16, and the distal end 15 includes a distal face 15a. The distal face 15a may be a cross section of the optical fiber 12, and may be coated (for example, if at least a portion of the distal face 15a includes a thin layer of reflective coating material) or uncoated. An optical grating 34 comprising a plurality of evenly spaced grooves 36 may be machined or etched onto the outer surface of the optical fiber 12, which may diffract incident light. The plurality of grooves 36 may be approximately 5 μm or less in depth. Additionally or alternatively, the optical grating 34 may comprise a frosting or increased opacity of certain areas within the fiber 12 at the distal end 15, areas of ink deposition, or a thin layer of gold or other metal. The optical grating 34 may be located on the distal face 15a of the fiber 12.

The distance 38 between the grooves 36 of the optical grating 34 may vary with pressure, and the magnitude of the variation may be a function of the material of the optical fiber 12 (i.e. the compressibility of the material from which the optical fiber 12 is composed). As pressure of the environment increases, the optical fiber 12 may become compressed and in turn reduce the distance 38 between the grooves 36 of the optical grating 34 (as shown in FIG. 4B). The insets of FIGS. 4A and 4B show an exaggerated view of the reduction in distance 38 between the grooves 36 as affected by pressure. The reduction in distance 38 is a dynamic respond in direct correlation to pressure changes. As the distance 38 changes, the spectrum of light 30 diffracted by the optical grating 34 may also change. However, whatever the distance 38 between the grooves 36, the distance 38 will be such that light is diffracted at wavelengths within the visible spectrum of light. The change of distance 38 between the grooves 36 affect the angle of diffraction of light, which can be measured with a spectrometer. Even a small change in the distance 38 can result in a significant change in the diffraction angle. For example, if the wavelength of light is approximately 600 nm, a distance between the grooves 36 of approximately 1200 nm will result in a maximum angle of diffraction of 30°. If the distance between the grooves 36 is increased by 5 nm, the angle of diffraction becomes approximately 29.86°, which represents a change of more than 4%. In this way, environmental pressure may be measured using interferometry, spectrometry, or optical coherence tomography (OCT).

Referring now to FIG. 5 the liquid pressure may be measured using a device 28 such as a spectrometer, which is well known in the art. The device 28 may be coupled to the proximal end 16 of the optical fiber 12. The device 28 may send waves of light (generally depicted with arrows) longitudinally through the core 32 of the optical fiber 12 to the distal end 15 of the optical fiber 12, and may detect the spectrum of light (generally depicted with arrows) that is transmitted back to the device 28. The device 28 may correlate the changes in the transmitted spectrum of light with changes in the distance 38 between the grooves 36 of the optical grating 34. The device 28 may then communicate the comparison as a pressure reading.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A pressure sensor comprising
an optical fiber having a distal end and a proximal end; and
one or more evacuated columns within the optical fiber and coterminous with the distal end of the optical fiber, the one or more evacuated columns having a diameter sized to allow for capillary action within.

2. The pressure sensor of claim 1, wherein the optical fiber is composed of a polymer.

3. The pressure sensor of claim 2, wherein the polymer is hydrophobic.

4. The pressure sensor of claim 3, wherein the optical fiber is put in contact with a liquid, the polymer having a hydrophobicity sufficient to produce a wetting angle between the optical fiber and the liquid of at least 90 degrees, and the one or more evacuated columns being sized to produce capillary action of the liquid therein.

5. The pressure sensor of claim 2, wherein the optical fiber is coated with a hydrophobic film and is put in contact with a liquid, the film having a hydrophobicity sufficient to produce a wetting angle between the film and the liquid of at least 90 degrees, and the one or more evacuated columns being sized to produce capillary action of the liquid therein.

6. The pressure sensor of claim 2, wherein the optical fiber comprises a core and a cladding, the core composed of a material selected from the group consisting of: poly(methyl methacrylate), an azypolymer, and an amorphous perfluorinated polymer; and
the cladding composed of a material selected from the group consisting of: polyethylene, polyvinyl chloride, polypropylene, crosslinked polyethylene, polyamide, silica, fluoride-based glass fibers, and phosphate-based glass fibers.

7. The pressure sensor of claim 3, wherein the amorphous perfluorinated polymer is polyperfluoro-butenylvinylether.

8. The pressure sensor of claim 2, wherein the optical fiber is a solid fiber in which one or more evacuated columns are created longitudinally along the core of the optical fiber by a method selected from the group consisting of machining and etching.

9. The pressure sensor of claim 8, wherein the one or more evacuated columns have a diameter of at least 5 nm.

10. The pressure sensor of claim 2, wherein the optical fiber is a hollow fiber having a hollow inner portion, the hollow inner portion defining the one or more evacuated columns within the optical fiber.

11. The pressure sensor of claim 10, wherein the one or more evacuated columns have a diameter of at least 5 nm.

12. The pressure sensor of claim 1, wherein the pressure is measured by a method selected from the group consisting of interferometry, spectrometry, and optical coherence tomography.

13. A pressure sensor comprising an optical fiber having a distal end, a proximal end, and a compression coefficient, the distal end including optical grating composed of a plurality of grooves on the outer surface of the optical fiber.

14. The pressure sensor of claim 12, wherein the optical fiber is composed of a polymer material.

15. The pressure sensor of claim 13, wherein the polymer material is poly(methyl methacrylate).

16. The pressure sensor of claim 13, wherein the optical fiber includes a core and a cladding.

17. The pressure sensor of claim 15, wherein the core is composed of a material selected from the group consisting of: poly(methyl methacrylate), an azypolymer, and an amorphous perfluorinated polymer; and
the cladding is composed of a material selected from the group consisting of: polyethylene, polyvinyl chloride, polypropylene, crosslinked polyethylene, polyamide, silica, fluoride-based glass fibers, and phosphate-based glass fibers.

18. The pressure sensor of claim 12, wherein the groove density of the optical grating is such that incident light is diffracted at wavelengths within the visible spectrum of light, regardless of the compression coefficient of the optical fiber.
